(19) United States
(12) Patent Application Publication
(10) Pub. No.: US 2014/0279899 A1
(43) Pub. Date: Sep. 18, 2014

(54) DATA BUS ARCHITECTURE FOR INTER-DATABASE DATA DISTRIBUTION

(71) Applicants: Charlie Gu, Shanghai (CN); Michael Harvey, Brisbane (AU); Douglas Tolbert, Irvine, CA (US)

(72) Inventors: Charlie Gu, Shanghai (CN); Michael Harvey, Brisbane (AU); Douglas Tolbert, Irvine, CA (US)

(73) Assignee: Unisys Corporation, Blue Bell, PA (US)

(21) Appl. No.: 13/961,141

(22) Filed: Aug. 7, 2013

Related U.S. Application Data
(60) Provisional application No. 61/786,966, filed on Mar. 15, 2013.

(51) Int. Cl. G06F 17/30

(52) U.S. Cl. CPC G06F 17/30575
USPC 707/634

(57) ABSTRACT

Systems and methods for managing distributed data using any of a plurality of data models are disclosed. One method includes receiving a data request from one of a plurality of database interfaces, each database interface associated with a different data model type. The method further includes translating the data request to a second data request based at least in part on a data model neutral description of a data model in the data store that is associated with data and the database interface, wherein the data store maintains descriptions of each of a plurality of different data models corresponding to the different data model types. The method also includes executing the second data request, thereby reflecting the data request in data storage such that data is managed consistently across each of the plurality of database interfaces.

### TECHNICAL FIELD

The present application relates generally to data architectures, in particular, the present application relates generally to a data bus architecture arrangement providing for systems for efficient inter-database data distribution.

### BACKGROUND

In traditional system architectures, an operating system executes on computing hardware, and can host a particular database management system and database storage arrangement. For example, selected computer hardware having a particular system architecture (e.g., compliant with the x86, x86-64, IA64, PowerPC, ARM, or other system architectures) can host an operating system specifically written for or compiled for that architecture. That operating system (e.g., Windows, Linux, etc.) can then host a corresponding database and associated database management system.

Within this construct, various database architectures have emerged. For example, relational databases have been developed, in which data requests, such as queries, can be submitted in a relational query structure (e.g., using SQL or some similar language). Generally, data in such relational databases are stored in records, with interrelationships across table entries in one or more tables, with query results returned in terms of row and table references. In other examples, hierarchical databases have also been developed which store data in records, but generally query results are returned in record and set references. Still other database architectures are implemented using different access procedures, such as storage in columns, records, streams, or other structures.

Increasingly, a number of limitations of computing infrastructure have begun to affect these database arrangements. For example, some relational and hierarchical database management systems assume all data is to be stored on a particular partition or computing system, and as such are either unable to or are inefficient at obtaining data stored in separate memories or memory partitions. Furthermore, existing application level programs may be written for use with a relational system when data is stored in a hierarchical database, or vice versa, thereby complicating data access issues. In such situations, it may be the case that separate transactional and relational database instances must be maintained, leading to data consistency and replication difficulties. Or, hierarchical database commands must be translated to a relational database language, accounting for the difference between such data models. In both circumstances, inefficiencies exist in storage and retrieval of data, and limitations as to methods (i.e., database commands and query languages) persist. This issue is exacerbated by the fact that many organizations wish to maintain many different types of databases, for example transactional databases for managing sales or operational transactions, relational databases for maintaining company records, and multidimensional databases for analytics.

For these and other reasons, improvements are desirable.

### SUMMARY

In accordance with the following disclosure, the above and other issues are addressed by the following:

In a first aspect, a system for maintaining data across heterogeneous data storage environments is disclosed. The system includes a first database interface having a first data model type associated with a data storage environment storing first data. The system further includes a first agent capable of inspecting the data and data relationships within the data storage environment, wherein the first agent is configured to detect changes in the first data and in the data model. The system also includes a second agent associated with a second database interface having a second data model type and associated with a second data storage environment, the second data storage environment including a database storing second data, and wherein the second agent is configured to detect changes in the second data stored in the database and in the data model, wherein the first and second data models are different. The system further includes a partition executing on a computing system separate from the first database interface, first agent, or second agent, the partition including a data bus application executing thereon and configured to coordinate with the first and second agents to automatically maintain synchronization between the first and second data and maintain analogous first and second data models across the first and second data storage environments.

In a second aspect, a computer-implemented method for maintaining data among a plurality of heterogeneous data storage environments is disclosed. The method includes detecting, by a first agent, changes in data and in a data model of a first database interface, the first database interface associated with a data storage environment storing data and data relationships. The method further includes detecting, by a second agent, changes in data and in a second data model of a second database interface, the second database interface associated with a second data storage environment including a database and residing separate from the data storage environment, and wherein the first and second data models represent heterogeneous data models. The method also includes coordinating the first and second agents to automatically maintain synchronization between data in the data storage environment and data in the second data storage environment through a partition executing on a computing system separate from the first or second database management systems.

In a third aspect, a computer-readable storage medium comprising computer-executable instructions which, when executed by a computing system, cause the computing system to perform a method of maintaining data among a plurality of heterogeneous data storage environments is disclosed. The method includes detecting, by a first agent, changes in data and in a data model of a first database interface, the first database interface associated with a data storage environment storing data and data relationships. The method further includes detecting, by a second agent, changes in data and in a second data model of a second database interface, the second database interface associated with a second data storage environment including a database and residing separate from the data storage environment, and wherein the first and second data models represent heterogeneous data model. The method also includes coordinating the first and second agents to automatically maintain synchronization between data in the data storage environment and data in the second data storage environment through a partition executing on a computing system separate from the first or second database management systems.

### BRIEF DESCRIPTION OF THE DRAWINGS

FIG. 1 is a logical diagram of a data storage system according to an example embodiment of the present disclosure;

FIG. 2 is a logical diagram of a data storage system according to a second possible embodiment;

FIG. 3 is an example logical diagram illustrating a layout of computing resources in an environment implementing either of the data storage systems of FIGS. 1-2;

FIG. 4 is a block diagram of an electronic computer system useable within the data storage system disclosed herein;

FIG. 5 is an example of a logical diagram illustrating aspects of a data bus system for maintaining data across heterogeneous data storage environments disclosed herein;

FIG. 6 is a block diagram of a data bus system in which database architectures are provided to the data bus system, according to an example embodiment;

FIG. 7 is a block diagram of the data bus system of FIG. 6 in which outbound code is generated, according to another example embodiment;

FIG. 8 is a block diagram of the data bus system of FIG. 6 in which inbound code is generated, according to another example embodiment;

FIG. 9 is a block diagram of the data bus system of FIG. 6 in which outbound replication occurs, according to an example embodiment;

FIG. 10 is a block diagram of the data bus system of FIG. 6 in which inbound replication occurs, according to an example embodiment;

FIG. 11 is a block diagram of a portion of the data bus system of FIG. 6 in which administration messages are sent in runtime to database partitions, according to an example embodiment;

FIG. 12 is a flowchart of a method maintaining data among a plurality of heterogeneous data storage environments;

FIG. 13 is a flowchart of a method for coordinating first and second agents to automatically maintain synchronization, according to an example embodiment; and

FIG. 14 is a flowchart of a method for coordinating first and second agents to automatically maintain synchronization, according to another example embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to database and data bus architectures. In particular, the present application relates generally to a data bus architecture arrangement providing for systems for efficient data distribution. The data bus architectures disclosed herein represent systems in which a unified, data model neutral data storage arrangement can be used as a data layer, with existing database management systems operating to provide different views into a unified, data model neutral data layer. In example embodiments, the data model neutral layer can maintain descriptions of the data models associated with each database interface to provide a definition that allows replication of data across different data models of different data model types. In other example embodiments, the data model neutral layer can maintain both descriptions of the data models associated with each database interface and a data model neutral data layer, thereby avoiding some replication of data but rather maintaining a single data model neutral set of data, upon which various views can be generated for each of a plurality of database interfaces having different data model types.

In particular, and as discussed below, FIGS. 1-4 represent systems in which a common data bus can be implemented, and in particular applications to which the common data bus can be directed, FIGS. 5-14 represent specific implementation details of such data bus features, and possible components of such a data bus arrangement, including, in some embodiments, agents, data services, and associated components.

In general, and as discussed herein, a data model corresponds to a particular arrangement of data for use in a database. For example, the data model can correspond to a particular database structure or schema that is specific to the data stored in a database. Analogously, a data model type, as referred to herein, corresponds to a particular type of arrangement of data, whether it be a relational, hierarchical, multidimensional, object oriented, columnar, network, record, or stream arrangements for data, or any other data model type. Accordingly, data model neutral data corresponds to data that is not stored in a manner that relies upon a particular data structure, but rather can be described across a variety of such structures. Examples of each of these concepts are generally provided in further detail below in conjunction with the various embodiments of the present disclosure.

Referring now to FIG. 1, a logical diagram of a data storage system 100 is shown, according to an example embodiment of the present disclosure. In general, the data storage system 100 corresponds to an implementation of a data storage system in which data models are described in a data model neutral arrangement, but in which data is maintained associated with existing database systems. Accordingly, the data storage system 100 represents an arrangement in which a data model neutral software layer operates as a data bus for exchanging data across various databases each managed by separate database management systems, or database interfaces, having different data model types.

In the embodiment shown, the data storage system 100 includes a virtualization space 101 executable on a hardware layer 102. The hardware layer 102 supports secure partition services 104. The hardware layer 102 generally corresponds to a large, multiprocessor, networked arrangement including a plurality of computing systems. As further discussed below in connection with FIGS. 4-5, the hardware layer 102 can be assigned to and affiliated with particular portions of the data storage system 100 in a variety of ways, but generally provides processing and memory resources useable to implement a database and database application architecture. The hardware layer can be constructed from one or more server computers, an example of which is discussed below in connection with FIG. 3.

The secure partition services 104 provides a low-level software layer above the hardware layer 102, and generally corresponds to a virtualization layer useable to host various types of operating systems that may or may not be compatible with the hardware layer 102. For example, the secure partition services 104 can correspond to a hypervisor software layer installed on one or more computing systems, capable of collectively partitioning available hardware resources available within a computing system into a plurality of partitions. As discussed below in connection with FIG. 4, each of the partitions represent a defined collection of hardware resources capable of being allocated to a hosted operating system, such that the hosted system views the allocated resources, via the hypervisor, as a computing system itself. In one example embodiment, the secure partition services 104 correspond to S-Par secure partitioning hypervisor software from Unisys Corporation of Blue Bell, Pa. Of course, other secure partition services could be used as well.

In the embodiment shown, the secure partition services 104 host a set of architecture attributes 106 and a common data bus 108. The architecture attributes 106 reside in a layer above the secure partition services 104, in that they are published to various partitions 110 (shown as partitions 110a-d). In various embodiments, the architecture attributes 106 can include, for example, emulated processing, memory, networking and/or other attributes made available to the partitions 110.

The common data bus 108 hosts and supports data exchange across the plurality of partitions 110, to allow for cross-pollination of data between the partitions, for use by the operating systems and software installed thereon. In particular, the common data bus 108 stores metadata describing, for example, a particular file system and/or database structure or schema used in a particular partition, such that when data is stored or altered in that partition, the common data bus 108 detects the data change and replicates that change of data across the other partitions. In various embodiments, the common data bus 108 can be configured to detect changes in data in virtual file systems or virtual database files in the various partitions 110, and replicate data between those systems based on known interrelationships between those data structures. For example, the common data bus 108 can be implemented using one or more transforms developed between source and target computing system file systems and/or database systems, and includes the software necessary to support export of data from each partition (e.g., from the file system within a particular partition, or within a database having a schema hosted within the partition). Details regarding implementation of the common data bus 108 are provided in further detail in FIGS. 3-11, below.

In the embodiment shown, each of the partitions 110 supported by the secure partition services 104 and common data bus 108 are configured to support any of a variety of operating systems and/or database management systems and database architectures. In the example depicted, a first partition 110.a hosts a first operating system, depicted as an MCP operating system provided by Unisys Corporation of Blue Bell, Pa. Similarly, other partitions within the system may host different types of systems; in the embodiment shown, a second partition 110b hosts a second operating system, shown as the OS2200 operating system, also from Unisys Corporation of Blue Bell, Pa. A third operating system simply illustrated as a coprocessor, or “CP” is also illustrated as associated with a third partition 110c. Other partitions, such as partitions maintaining third party operating systems (e.g., Linux, Windows-based, or other operating systems) could be incorporated as welt.

Within each of the partitions 110a-c, each partition may include one or more data personalities 112. Data personalities 112 generally refer to structures or arrangements by which data is accessed and understood. For example, data personalities may correspond to a data model type of a database, such as a relational, hierarchical, multidimensional, columnar, network, record, stream or object oriented data model type. Data personalities generally describe the expected operation of an interface to data, rather than the specific structure of a given data set. Such a specific structure, or data model, corresponds to a particular schema of that data set as may be designed within the data model type.

In the example embodiment shown, the first partition 110a including the MCP operating system hosts two data personalities, a relational data personality 112a (such as would be expected of a SQL or other relational database) and a DMSII personality 112b, useable with DMSII database management system from Unisys Corporation of Blue Bell, Pa. Similarly, the second partition 110b is illustrated as supporting an RDMS personality 112c, a DMS personality 112d, and indexed files in a file system (i.e., a file-based data personality 112e).

In the arrangement shown, each of the partitions 110a-c can be made available to a further partition or application executing within one of those partitions, illustrated as a data access application 114. The application 114 can access one or more APIs 116, shown as traditional APIs 116a and third party APIs 116b for accessing data stored using nonstandard third party data personalities. The APIs 116 are published for use with each of the variety of data personalities 112, for accessing data in the various partitions. As such, the application can access data as needed from each of the various data personalities—e.g., in a relational format from a relational database personality such as personality 112a, or hierarchical data from a hierarchical database personality (e.g., the DMSII personality 112), or other data access arrangements.

Use of a common data bus 108 to provide data synchronization across partitions, in particular in an example arrangement such as that depicted in FIG. 1, provides a number of advantages over existing hypervisor systems or even existing data replication systems. Because an application can access data from each of the various data personalities, the application can be designed to access data according to different personalities (rather than being written to interface with a particular data model type), and can request and receive data from a selected personality based on the suitability of the data model type associated with that data personality. For example, an application could both store data according to a DMSII data personality 112b, and could retrieve data in a reporting format from a relational data personality 112a, or a multidimensional data personality, or some other convenient format. Using the common data bus 108, each of the data personalities is kept up-to-date via transformations of the data at the time it is stored in each personality, thereby providing convenient retrieval of data in a convenient format, from a supported API, at the application level regardless of whether the data was originally stored in a database having the particular personality from which retrieval is desired. As such, data is available from each of the data personalities 112 at essentially data retrieval speeds, since each data personality would not be required to communicate across to other data personalities to retrieve such data (assuming sufficient time between data storage in one data personality and retrieval in another data personality to allow for replication of the data in each of the data models and data model types associated with each of the personalities supported within a particular system. Optionally, an application development environment 118 could be included as well which allows a designer to create applications designed to interface with various data personalities via the APIs 116a-b. The data personalities 112 allow applications to be written using the application development environment 118 that are capable of accessing data from any of the personalities.

As illustrated in system 100, a remote system 120, such as a client system or other remote server, can be communicatively connected to the virtual system 101, e.g., for communication with the application 114, or application development environment 118. For example, the application 114 or application development environment can have a web interface, either directly supported within one of the partitions in which the application or application development environment reside, or in a separate partition, managing access to that system.

It is noted that, as illustrated, other third party systems can be incorporated into the overall system 100. In the embodiment shown, one such third party system 122 can be included within the overall virtualized system 101, hosted by secure partitioning services 104, and a further third party system 124 is remote from the overall system 100, and communicatively connected to the system by the common data bus 108. These third party systems are shown to illustrate example interoperability of the common data bus 108 with third party systems. In connection with third party system 122, the common data bus 108 can be extended, on a case-by-case basis, to such third party systems by establishing a relationship between known data personalities of the supported systems and those developed by third parties. In the example shown, both third party systems 122, 124 operate third party operating systems 126, 128, respectively, and have specific third party data personalities 130, 132. These may be the same, or different, operating systems and/or data personalities. Further, as illustrated in FIG. 1, third party operating system 128 can be communicatively connected to the system despite running on incompatible third party hardware 134.

Although the system 100 of FIG. 1 has numerous advantages, it is noted that, in particular for large data collections, some inefficiencies may exist, for example due to the requirement that data be replicated as many times as there are different data personalities. Accordingly, and as illustrated in FIG. 2, an alternative embodiment of a database and data bus architecture is contemplated, in which a system 200 reduces the amount of data replication involved. In connection with the system 200, a common data store 202 takes the place of the common data bus 108 for at least a supported portion of the system 200, namely one or more partitions 110 having known data personalities. In this embodiment, each of the partitions that are capable of connection to the common data store 202 no longer are required to independently maintain storage of data associated with the particular data personalities to which they relate, but instead request data from a common data store that stores data in a data model neutral format. Although examples of such a format are discussed in further detail below, it is noted here that any of a variety of formats that do not specifically rely on positional interrelationships among data elements (e.g., within a common table or data record) to define relationships can be used. For example, unstructured data, such as key-value pairs or other types of data labeling, could be used.

In the particular embodiment shown, the common data store 202 is configured to provide an interface between each of a plurality of data personalities 112 and the underlying data by providing a conduit for data storage from each of the supported partitions 110. In the embodiment shown, the common data store 202 is interfaced to partitions 110a-c, and provides data to data personalities 112a-f. As such, data personalities 112a-f rather than representing database systems as in FIG. 1, effectively act as data views on data in the common data store 202.

The common data store 202 can be interfaced to a common data bus 204, which acts analogously to the common data bus 108 of FIG. 1, but for only unsupported data structures, i.e., data personalities for which the common data bus 204 may have some knowledge of the data format type, but the common data store 202 lacks knowledge of the data format of the data personality itself. In other words, the common data store acts as a structure-independent database capable of being maintained in synchronization with external data personalities, such as data personalities 112g, 112h, using the common data bus 204. In this arrangement, the common data bus 204 would not be required to directly interface with data personalities 112a-f, since those data personalities would not directly store data; rather, the common data store 202 would manage that data, and would be maintained in synchronization with the common data bus 204.

In the embodiment shown, it is noted that additional features can be incorporated in the common data store 202, in addition to those managed in the common data bus 204. For example, functionalities that are related to database functions but which are not part of a particular data model can entirely be managed within the common data store; for example, transaction management, recovery, backup, and other data functions can be managed within the common data store 202. Other functionalities typically associated with database management systems could be incorporated into a common data store as well.

It is noted that this overall systems depicted in FIGS. 1-2 allow for use of data personalities by application programs in the same manner as is traditionally provided by database management systems. Accordingly, since such an arrangement is typically located in a large-scale multi-server environment, applications have a choice regarding the specific data personality from which data is requested, despite the fact that data may not have originally been stored using that data personality, and in the implementation of FIGS. 1-2, the data is maintained either in a data model neutral format, or replication is provided by way of the common data bus 108, 204.

Referring now to FIG. 3, an example arrangement 300 of systems is illustrated, on which the systems of FIG. 1-2, and those of FIGS. 5-14, described below, can be implemented. In the embodiment shown, the arrangement 200 includes a plurality of logical computing systems 302a-d, or partitions. Each of the logical computing systems 302a-d can include a collection of computing resources, such as a processor, memory resources, disk resource, network or communications resources, and other resources typically present on a computing system. An example of a collection of physical computing resources, formed as a typical discrete electronic computing system is described below in connection with FIG. 4.

In general, each of the logical computing systems 302a-d hosts secure partition services 304, which define the set of physical computing resources available to higher-layer software, as well as providing an interface between that higher-layer software and the physical computing resources allocated to the particular logical computing system 302. Furthermore, the partition services 304 provide virtualization and security services, as well as backup and recovery services, for each partition.

In the embodiment shown, the arrangement 300 includes a control partition 306, guest partitions 308a-b, and a services partition 310. The control partition 406 schedules allocation of additional partitions to various guest processes as desired. For example, the control partition 306 can execute a console application configured to allow reservation of resources for various guest partitions and/or service partitions. The guest partitions 308a-b can execute any of a variety of guest applications. For example, the guest partitions 308a-b can host separate database management systems or data personalities on different hosted operating systems. Still further guest partitions (not shown) could host data storage partitions, or an implementation of the common data bus or common data store, a map-reduce service operation useable by the common data store, or other types of services discussed above. A services partition 310 hosts one or more services useable by the guest partitions, such as for remote systems communications, data management/replication, or other services.

When implementing a system such as that shown in FIGS. 1-2 above in a virtualized computing arrangement, it is noted that although an example set of hosted, virtualized partitions are shown, other partitions could be included in such a system for hosting additional data personalities, applications, data nodes, data processing software, networking operations, or specialty processes. Furthermore, in some embodiments, at least some of the computing arrangements of FIGS. 1-2 can be implemented natively on a local system, rather than on a virtualized system.

Referring now to FIG. 4, a schematic illustration of an example computing system in which aspects of the present disclosure can be implemented. The computing system 400 can represent, for example, a native computing system within which one or more of computing systems 202a-d, or with multiple of which the systems 100, 120, 124, 200 could be implemented.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as a cathode-ray tube display, an LCD display panel, a plasma screen display panel, a touch-sensitive display panel, an LED screen, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a. PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. However, such computer readable media, and in particular computer readable storage media, are generally implemented via systems that include at least some non-transitory storage of instructions and data that implements the subject matter disclosed herein.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Referring now to FIGS. 5-14, additional details are provided regarding data bus systems useable within the data storage systems 100, 200 of FIGS. 1-2. In particular, FIG. 5 illustrates a simplified logical diagram of aspects of an example data bus system 500 for maintaining data across heterogeneous data storage environments is shown. In some embodiments, a data bus system 500 includes a plurality of partitions, including database partitions 502a-c and a data bus partition 504. Generally, one or more of the database partitions 502a-c, as well as the data bus partition 504, are communicatively connected via an interconnect system 506, such as the S-Par secure partitioning hypervisor software available from Unisys Corporation of Blue Bell, Pa. Additionally, one or more remote partitions, such as partition 502c, can be communicatively connected to the data bus partition 504, for example via a LAN connection 508.

In the embodiment shown, each of the database partitions 502a-c hosts one or more applications 510a-c, respectively, as well as an agent 512a-c and associated database 514a-c. Each of the applications 510a-c, agents 512a-c, and databases 514a-c can be hosted within an operating system. It is noted that, in varying embodiments, varying operating systems and associated databases 514a-c and/or applications 510a-c can be used. For example, one or more of the partitions 502a-c could include an OS2200 operating system, and a DMSII database system, while another of the internal partitions could use an MCP operating system and a DMSII database system. Alternatively, one of the internal partitions 502a-c could include a. Windows operating system and SQL Server database system, or a Linux operating system and associated Oracle or other third party database system. Applications useable to access data in the associated database system, and operable within the operating system associated with that database system, could be used as applications 510a-b as well. In still further embodiments, the databases 514a-c can correspond any data model type, such as relational, hierarchical, multidimensional, columnar, network, record, stream, or object oriented data model type.

The databases 514a-c provide, for example, a view on an underlying database, such as are provided by the various data personalities 112 of FIGS. 1-2. The databases 514a-c can be separate databases communicatively connected by a common data bus (e.g., common data bus 114, 204) or can represent views on a common data store, such as common data store 202.

In some embodiments, the agent 512 associated with each of the database interfaces is generally configured to (1) monitor that database interface for changed data or a changed database schema, and (2) initiate propagation of any such changes to other databases present within the overall system 500. In particular, the agents 512a-c are configured to determine a schema associated with the database 514 in the associated partition in which they reside, and capture changed data in that associated database. The agents 512a-c are further configured to persist changed data and/or schemas from other databases into the database with which they are associated. In some embodiments, the agents 512a-c can accomplish this task by monitoring transaction logs of the database with which they are associated. The agents 512a-c communicatively connect to the data bus partition 504, which provides definitions of transforms to be performed to ensure synchronization of data between databases having, for example, different data models, different data types, and different data.

In some embodiments each agent 512 is implemented such that it captures data by monitoring an audit log of the database with which it is associated. This allows the agent to minimize its performance impact on the database it is monitoring for changed data. In this case, the delay in replication of data from the database is constrained by the speed that the agent 512 reads and processes the audit entries.

The data bus partition 504 hosts a data bus application, including a data bus developer application 516a and a data bus runtime application 516b. The data bus developer application 516a includes a user interface portion configured to allow a user to define one or more transformations between selected source and target databases. As discussed in further detail below, the data bus developer application 516a is configured to generate one or more runtime modules that can be used to provide data transformations between two databases, including transformations of data structures and data types, as applicable. The data bus developer application 516a can, in some embodiments, generate modules including data bus runtime applications 516b, that can be used to perform transformations between database types. The data bus runtime application 516b is configured to provide such transformations, either on a one-to-one or one-to-many basis, among databases. In some embodiments, data bus runtime application 516b is generated by the data bus developer application 516a in the form of a DLL, JAR file, or other low-level executable file that can operate on data received at the data bus partition 504 from a particular source, and in particular from a specific, designated agent 512 associated with that source.

In some example embodiments, the data bus partition 504, and in particular the data bus runtime application 516b (after its generation by data bus developer application 516a), coordinates with a first agent at a source (e.g., agent 512a) associated with a database (e.g., database 514a), as well as a second agent (e.g., agent 512b) and associated database (e.g., database 514b) to automatically maintain synchronization between the data within each database and maintain analogous data models and data across the storage environments of the partitions 502a-b. The interconnection between the data bus partition 504 and the various agents 512a-c can take a variety of forms. In some embodiments, the interconnection is accomplished using the S-Par secure partitioning hypervisor and interconnect software previously incorporated by reference, which passes data between the agents and a corresponding ADO.NET software interface at the data bus partition.

It is noted further that, in operation, the data bus partition 504 must be able to propagate data changes in the order received, for example in the case of conflicting data changes. In such cases, a message queue 518 can be integrated at the data bus partition 504, for example as integrated with the data bus developer application 516a which can act as a supervisory application to the various data bus runtime applications 516b during operation of the data bus. The message queue 518 provides first-in, first-out message ordering, and can be implemented using, for example, a lightweight MQ for Unisys-based partitions implementing the data bus, or alternatively the MSMQ service if the data bus partition 602 is implemented using a Windows-based solution (e.g., in which the data bus runtime application 516b is implemented as one or more DLL files).

In some embodiments, the data bus developer application 516a allows a user to define schema mappings between source and target databases that will be propagated to a resulting data bus runtime application 516b generated by the developer application 516a. For example, definitions may include a source database table update that results in updates to multiple destinations (target databases). In such cases, the data bus runtime application 516b may be implemented as multiple separate DLL files.

To formulate the appropriate transformations, the data bus developer application 516a maintains a metadata repository of database schemas. The data bus developer application 516a includes its own metastore format, such as the CWM (Common Warehouse Metamodel) standard, and can also store schemas sourced from proprietary data managers (DMSII, RDMS 2200 and DMS 2200 from Unisys Corporation, or other data managers from third party database providers). The data bus developer application 516a loads schema definitions of particular databases from agents, such as agents 512, using any of a variety of protocols. For example, for an MCP-based database, a DASDL description file can be received at the metastore of the data bus developer application 516a, while in the case of an OS2200 database, a specific interface is developed to receive schema definitions from the UREP schema repository. Schema information from SQL Server and Oracle will be retrieved by the data bus developer application 516a using standard SQL interfaces.

Referring now to FIGS. 6-10, example operations of a data bus partition and associated components residing in database partitions, either within an overall environment or on third party computing systems, are disclosed. FIG. 6 illustrates a data bus system 600 that includes a data bus partition 602 communicatively connected to a first partition 604 containing a first database 606, and a second partition 608 that contains a second database 610. The first and second databases 606, 610, represent source and target databases, respectively, and correspond to database systems from different manufacturers or providing different types of views upon data, as explained above.

In the embodiment shown, the data bus partition 602 includes a data bus application 612, which can, in some embodiments, correspond to the data bus developer application 516a of FIG. 5. The data bus application 612 is generally configured to create one or more data bus runtime services 614, which define a one-to-one or one-to-many one-way transformation between a data model of a source database, such as database 606, and a data model of a target database, such as database 610. In the embodiment shown, the agent 616 is configured to inspect a database schema of source database 606, and can transfer that schema information to the data bus application 612. Likewise, the second agent 618 can receive schema information from the second database 610, and provide that schema information to the data bus application 612. Based on the first and second schemas, the data bus application can define a transformation that would be required to occur to transfer data from the source database 606 to the target database 610. Based on that determination, the data bus application 612 generates the data bus runtime service 612, which is used to provide subsequent transformations to ensure data updates from database 606 to database 610. In particular, first agent 616 can monitor a transaction log associated with the database 606 to determine when data or database structure has changed, and can transfer such data or data structure changes to the data bus partition 602, for communication to the target database.

It is noted that, in cases where data changes in both databases 606, 610, although multiple agents may not be required, it is recognized that multiple runtime services 612 may be used. For example, using the arrangement of FIG. 6, two such agents could be used, with one designating database 606 as the source database and database 610 as a target database, and a second agent designating database 610 as the source database and database 606 as the target database.

In addition, it is noted that various applications can be associated with the different databases 606, 610. In the embodiment shown, a first application 620 is associated with database 606, and a second application 622 is associated with database 610. These applications may be, in various embodiments, specifically configured to operate with the types of databases (and corresponding data models supported by those databases) that are provided at the different partitions 604, 608. For example, it is likely the case that, if databases 606, 610 support different data models, application 620 would be incompatible with database 610, and application 622 would be incompatible with database 606. This would at least mean that the applications would be configured to expect to receive data having a format different from the one that would be provided by that different database. However, by maintaining data across the databases 606, 610, either application could be used to query, analyze, and modify that same data, since the data would be maintained across those otherwise incompatible database types.

Referring now to FIGS. 7-11, arrangements are disclosed in which both of the source and target databases, e.g., databases 606, 610, are not directly compatible with the system 600 of the present disclosure. In particular, the arrangements illustrate cases where data is maintained across databases where one of the databases, e.g., database 606, corresponds to a database system having a known structure to the data bus partition 602, and in particular a system for which an agent has been developed for interfacing with a database, while the second database lacks a corresponding agent, for example because the second database is located on third party hardware, or because the second database is a third party database, such as may be hosted on third party hardware 124 of FIGS. 1-2. In some such embodiments, the first database 606 could, for example, correspond to a DMSII or RDMS database management system from Unisys Corporation of Blue Bell, Pa., while the second database 610 could correspond to a SQL database from Microsoft Corporation of Redmond, Wash. or an Oracle database from Oracle Corporation of Redwood City, Calif., respectively.

Referring now to FIG. 7, a data definition operation within the system 600 is shown. The data definition operation of FIG. 7 allows a user to define, for purposes of outbound code generation, and at the data bus partition 602, the extent to which data in a database is exposed to third party databases via the data bus. In particular, the data definition operation involves defining, from the data bus application 612, that either all or fewer than all data tables within a database are intended to be monitored. In this operation, a change data definitions operation 702 is performed by the data bus application 612, notifying the agent 616 of the internal database 606 to monitor only for changes in selected portions of database 606.

FIG. 8 illustrates a data definition operation within the system 600 is shown. In contrast to the data definition operation depicted in FIG. 7, in FIG. 8, the data bus partition 602 is configuring the agent 616 to receive data from a third party database 610. In this example, the third party database 610 includes a request broker 802 and a change data capture module 804. The data bus application 612 provides a code module to the agent 616, for example to define operations to be performed by the agent 616 when the agent receives data from a corresponding data bus runtime service 614 to be generated by the data bus application. The data bus application 616 also delivers a data definition to the change data capture module 804 of the third party database 610, to be propagated to the database 610 as a database schema. The change data capture module 804 corresponds to an interface to the database 610 that can detect changes to the database schema, and manage data communication The request broker 802 generally manages requests for data at the database 610, and can correspond, for example, to a request broker of an Oracle database, or equivalent service of another type of third party database.

As compared to the process shown in FIG. 7, the code provided to the agent differs. In FIG. 7, the agent is provided with a definition of a change agent, meaning that the agent 616 monitors for changes of database 606. In the case of FIG. 8, the agent 616 is provided instructions regarding the data types and data sent from the data bus runtime service 614, and where the target database is, so that the agent 616 can act to store the received data set. In other words, FIG. 8 represents a definition of agent operations in a case where data travels an opposite direction as compared to FIG. 7. The associated data bus runtime service 614 performs the actual transformations of data received from database 610 to database 606, which is provided to the agent 616.

FIGS. 9-10 illustrate inbound and outbound data replication processes, for example as may be performed using the data bus runtime service 614. The data replication processes may occur, for example, after setting up the types of data to be maintained across the databases using the data bus application 612. Referring specifically to FIG. 9, the system 600 of FIG. 6 is shown, in which an outbound data replication process occurs. As illustrated in FIG. 9, this corresponds to a process by which replication is performed from an “internal” database, such as database 606, to an “external” database, such as database 610.

In particular the data replication process involves the agent 616, at the source database 606, detecting a change in the source database 606, for example by inspecting a transaction log associated with the source database. The agent 616 is constructed to transmit that changed data to a data bus runtime service 614 at the data bus partition 602. The data definition operation of FIG. 9 differs from the exchange of data between agents as illustrated in FIG. 6, above, because in the arrangement shown in FIG. 8, database 610 lacks an associated agent. Accordingly, the data bus runtime service 614 directs transformed data directly to the database 610 for storage, rather than via an agent (if no agent is available).

Referring now to FIG. 10, outbound replication is shown, in the context of the system 600. In this arrangement, changed data is retrieved from the request broker 802, as noted above in FIG. 8. The request broker 802 receives changed data from the change data capture module 804, and the request broker 802 provides the changed data to the associated data bus runtime service 614. The data bus runtime service 614 can then transform the data, and provide the change data to the agent 616, for storage in the database 606.

In this scenario, the database 610, and in particular change tables within the database, (e.g., a SQL Server and Oracle Change tables) will have been configured for capturing database updates. One or more monitor processes (e.g., the change data capture module 804) will interrogate the change tables for updates whereby the data bus runtime service 614 will apply the transformation(s) that have been defined for use of that data in the target database(s), such as database 606. It is noted that, as received, the transformed data will be posted to a message queue, as noted in FIG. 5, for delivery to the agent 616 for storage.

Referring now to FIG. 11, a block diagram of a portion 1100 of the data bus system 600 of FIG. 6 is shown, in which administration messages are sent in runtime to database partitions, according to an example embodiment. As illustrated in FIG. 11, an administration tool 1102 can provide a user interface to one or both of the data bus application 612 and data bus runtime service 614. The data bus administration tool 1102 generally provides control in the runtime environment, and can provide reporting and monitoring of the health and status of various modules (e.g., agents or different data bus runtime services 614 of the overall data bus implementation.

In embodiments where the data bus partition 602 is implemented in a Windows-based environment, the administration tool 1102 can be implemented using a WPF graphical user interface via a Windows Communication Foundation. In alternative embodiments, including those where non-Windows systems are used to implement the data bus partition 602, other types of implementations of user interfaces and message/status handling systems could be used.

In various embodiments, the administration tool 1102 is configured to control deployment of the data bus runtime services 614, and can transmit control messages (as illustrated) to the data bus runtime services, for example to control operation of those services. The administration tool 1102 can also communicate messages to the agents, such as agent 616. For example, in the embodiment shown, the administration tool 1102 directs a control message to the agent 616 via the data bus runtime service 614 associated with that agent. In alternative embodiments, the administration tool 1102 can directly communicate with the agent 616. For example, the administration tool 1102 can be configured to track last “known good” status of data bus runtime services 614 and agents 616, control deployment of the data bus runtime services 614 once the transformations and operations of each data bus runtime service 614 is defined in the data bus application 612.

Referring to FIGS. 5-11 generally it is noted that although a limited number of partitions and databases are illustrated herein, it is recognized that additional databases and associated partitions could be used. Additionally, the systems disclosed herein are highly scalable, since transformations will take place only on the data bus partition, thereby not harming performance of database partitions. Furthermore, separate runtime services are provided for each defined transformation, so in case of a failure of one transformation or service, remaining portions of the data bus service can be maintained, while recovery operations are performed on the failed service (e.g., via administration tool 1102).

Referring now to FIGS. 12-14, example methods for maintaining data among a plurality of heterogeneous data storage environments according to the embodiments described above in connection with FIGS. 5-11. FIG. 12 illustrates a flowchart representing a method 1200 of maintaining data among a plurality of heterogeneous data storage environments, according to an example embodiment. FIG. 8 therefore represents a method 800 that can be performed by a data bus partition 504 of FIG. 5, or partition 602 of FIGS. 6-11.

The method 1200 of FIG. 12 is instantiated when the data bus partition detects a change in data in a first database interface (step 1202). In the method 1200, the data bus partition can correspond to data bus partition 504 of FIG. 5, or partition 602 of FIGS. 6-11. The first database interface can be either an internal or external database, such as either the common data store or a database associated with a database management system having a particular schema. The database can detect a change in data, for example, by receiving a notification from an agent associated with the database at which the change occurs, or in the case of an external database, via a change data capture module 804.

In the embodiment shown, the data bus partition can also detect a change in data in a second database interface (step 1204) located external to the first database. The database can detect a change in data, for example, by receiving a notification from an agent associated with the second database, or via another interface to that second database in the case that the second database is an external database, e.g. via a change data capture module 804. In response to a detected change in the data, the common data bus partition coordinates the first and second agents to automatically maintain synchronization between data (step 1206). This can be performed, for example, using the message queue 518 of FIG. 5, as well as a plurality of data bus runtime services 516b, 614. This step is illustrated further in FIG. 13.

FIG. 13 illustrates a flowchart representing a method 1300 for coordinating one or more agents to automatically maintain synchronization across databases, according to an example embodiment. FIG. 13 therefore represents a method 1300 that can be performed by the data bus partition 504 of FIG. 5 or data bus partition 602 of FIGS. 6-11. The method 1300 is particularly useable with multiple agents in the case of maintaining data across multiple internal databases, as discussed in connection with FIGS. 5-6, or with one internal agent and in association with interfaces to external databases, as illustrated in FIGS. 8 and 10.

The example method 1300 of FIG. 13 begins when the data bus partition receives a notification of changed data, for example from a first agent associated with a first database, or from a change data capture module 804 (step 1302). For example, the first database can be an internal database communicatively connected with the data bus partition through an intra-partition communication service or it can be an external database communicatively connected over a LAN network. The data bus partition, and in particular the data bus runtime services 516b, 614 that are associated with that source database and/or agent, then transforms the changed data to second changed data according to a second database model (step 1304) having a different model type and located separately from the first database. This second database can be either an internal or external database. The data bus partition then transmits the second changed data to the second agent (or second database, in the case the second database is an external database) over the intra-partition communication service or over a LAN network, for example (step 1306).

FIG. 14 illustrates a flowchart of a method for coordinating one or more agents to automatically maintain synchronization, according to another example embodiment. FIG. 14 therefore represents a method 1400 that can be performed by the data bus partition 504 of FIG. 5, or partition 602 of FIGS. 6-11.

The example method 1400 of FIG. 14 begins when the data bus partition receives a notification of a changed data model from a first agent associated with a first database, or from the first database itself, such as from a request broker 802 (step 1402). For example, the first database can be an internal database communicatively connected with the data bus partition through an intra-partition communication service or it can be an external database communicatively connected over a LAN network. The data bus partition then defines a change in the data model according to a second data model associated with a second (e.g., target) database (step 1004) having a different model type and located separately from the first database. The data bus partition 504, 602 then transmits the second changed data model to the second agent or second database (in case of an external database) over the intra-partition communication service or over a LAN network, for example (step 1406). The agent associated with the second database, or analogous service, then updates the second data model according to the change (step 1408).

Referring to FIGS. 1-14 generally, it is recognized that the various systems and methods described herein provide a number of advantages over existing database systems, and in particular for large-scale, large fanout databases requiring many physical computing systems for implementation. For example, due to replication of data at multiple databases using the data bus of the present disclosure, the same data can be viewed in different locations, and in different hierarchical schemas. In particular, off-the-shelf applications written for use with a particular database structure can readily be used without modification, since data is maintained according to a variety of data models. Furthermore, there is less need for database replication outside of such a system due to automated data replication into different views. There can also be, in some embodiments, distribution of query tasks across many partitions and database management systems to avoid bogging down one particular hardware system with many complicated data requests. Other advantages are apparent as well from the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A system for maintaining data across heterogeneous data storage environments, the system comprising:
a first database interface having a first data model type and associated with a data storage environment storing first data;
a first agent capable of inspecting the data and data relationships within the data storage environment, the first agent configured to detect changes in the first data and in the data model;
a second agent associated with a second database interface having a second data model type and associated with a second data storage environment, the second data storage environment including a database storing second data, and wherein the second agent is configured to detect changes in the second data stored in the database and in the data model, wherein the first and second data models are different; and
a partition executing on a computing system separate from the first database interface, first agent, or second agent, the partition including a data bus application executing thereon and configured to coordinate with the first and second agents to automatically maintain synchronization between the first and second data and maintain analogous first and second data models across the first and second data storage environments.

2. The system of claim 1, wherein the first agent resides with the first database interface on a second computing system separate from the computing system on which the partition resides.

3. The system of claim 2, wherein the second agent and second database interface reside on a third computing system separate from the computing system and the second computing system.

4. The system of claim 3, wherein the first database interface and first agent operate within a second partition on the second computing system, and wherein the second agent and second database interface operate within a third partition executing on the third computing system.

5. The system of claim 1, wherein the first data model comprises a transactional data model, and wherein the second data model comprises to a relational data model.

6. The system of claim 1, wherein the data bus application includes a data bus runtime component defining a transformation from the first data model type to the second data model type.

7. The system of claim 1, wherein the data bus application includes a second data bus runtime component defining a second transformation from the second data model type to the first data model type.

8. The system of claim 1, further comprising a third database interface having a third data model and associated with the data storage environment.

9. The system of claim 8, wherein the data storage environment is implemented using a schemaless data repository, and wherein the data is stored as key-value pairs.

10. The system of claim 9, wherein the first and third database interfaces provide views on the schemaless data repository based on metadata describing relationships among the first data according to the respective first and third data models.

11. A computer-implemented method for maintaining data among a plurality of heterogeneous data storage environments, the method comprising:
detecting, by a first agent, changes in data and in a data model of a first database interface, the first database interface associated with a data storage environment storing data and data relationships;
detecting, by a second agent, changes in data and in a second data model of a second database interface, the second database interface associated with a second data storage environment including a database and residing separate from the data storage environment, and wherein the first and second data models represent heterogeneous data models; and
coordinating the first and second agents to automatically maintain synchronization between data in the data storage environment and data in the second data storage environment through a partition executing on a computing system separate from the first or second database management systems.

12. The computer-implemented method of claim 11, wherein the first agent resides with the first database interface on a second computing system separate from the computing system on which the partition resides.

13. The computer-implemented method of claim 11, wherein the data model comprises a transactional data model, and wherein the second data model comprises a relational data model.

14. The method of claim 11, wherein coordinating the first and second agents comprises:
receiving at the partition a notification of changed data from the first agent, the notification including the changed data;
transforming the changed data to second changed data according to the second data model using a first data bus runtime service; and
transmitting the second changed data to the second agent, which stores the changed data in the database included within the second data storage environment.

15. The method of claim 11, wherein coordinating the first and second agents comprises:
receiving at the partition a notification of a changed data model from the first agent, the notification including a description of the changed data model as compared to the data model;
defining a change to the second data model based on the changed data model at the partition; and
transmitting the change to the second data model to the second agent, which updates the second data model.

16. The method of claim 11, wherein coordinating the first and second agents comprises:
receiving at the partition a notification of changed data from the second agent, the notification including the changed data;
transforming the changed data to second changed data according to the first data model using a second data bus runtime service; and
transmitting the second changed data to the first agent, which stores the changed data in the first data storage environment.

17. The method of claim 11, wherein coordinating the first and second agents comprises:
receiving at the partition a notification of a changed data model from the second agent, the notification including a description of the changed data model as compared to the second data model;
defining a change to the data model based on the changed data model at the partition; and
transmitting the change to the data model to the first agent, which updates the data model.

18. The method of claim 11, wherein the partition implements a data bus application.

19. The method of claim 11, further comprising coordinating the first and second agents to automatically maintain correspondence between the first and second data models via the partition.

20. A computer-readable storage medium comprising computer-executable instructions which, when executed by a computing system, cause the computing system to perform a method of maintaining data among a plurality of heterogeneous data storage environments, the method comprising:
detecting, by a first agent, changes in data and in a data model of a first database interface, the first database interface associated with a data storage environment storing data and data relationships;
detecting, by a second agent, changes in data and in a second data model of a second database interface, the second database interface associated with a second data storage environment including a database and residing separate from the data storage environment, and wherein the first and second data models represent heterogeneous data models; and
coordinating the first and second agents to automatically maintain synchronization between data in the data storage environment and data in the second data storage environment through a partition executing on a computing system separate from the first or second database management systems.
